(19) United States
(12) Patent Application Publication
(10) Pub. No.: US 2020/0094821 A1
(43) Pub. Date: Mar. 26, 2020

(54) METHOD AND APPARATUS FOR CONTROLLING VEHICLE TO PREVENT ACCIDENT

(71) Applicant: LG Electronics Inc., Seoul (KR)

(72) Inventor: Cheolseung KIM, Seoul (KR)

(21) Appl. No.: 16/698,499

(22) Filed: Nov. 27, 2019

(30) Foreign Application Priority Data
Oct. 29, 2019 (KR) 1020190135435

(51) Int. Cl. B60W 30/09; G05D 1/00

(52) U.S. Cl. CPC B60W 30/09; B60W 2050/0089; G05D 1/0088

(57) ABSTRACT

Disclosed is a method for controlling a vehicle. The method for controlling a vehicle in a computing device includes acquiring driving information and sensing information from the vehicle driving in a specific section, identifying a correspondence relationship between history information associated with a past accident cause for at least one other vehicle having driven in the specific section and the acquired information, and generating a control signal for controlling the vehicle based on the identified correspondence relationship. At least one of an autonomous vehicle, a user terminal, and a server may be connected with an artificial intelligence (AI) module, an unmanned aerial vehicle (UAV), a robot, an augmented reality (AR) device, a virtual reality (VR) device, a device associated with a 5G service, and the like.

### CROSS-REFERENCE TO RELATED APPLICATION

This application claims the benefit of Korean Patent Application No. 10-2019-0135435, filed on Oct. 29, 2019, in the Korean Intellectual Property Office, the disclosure of which is incorporated herein in its entirety by reference.

BACKGROUND

### 1. Field

The present disclosure relates to a method and an apparatus for controlling a vehicle in a computing device to prevent an accident. One particular embodiment relates to a method and an apparatus for controlling a vehicle to prevent an accident predicted according to a correspondence relationship between history information regarding an accident cause for at least one other vehicle having driven in a specific section and information acquired from a vehicle currently traveling the specific section.

### 2. Description of the Related Art

A vehicle may be classified as an internal combustion engine vehicle, an external combustion engine vehicle, a gas turbine vehicle, or an electric vehicle by a type of engine. An autonomous vehicle refers to a vehicle capable of driving on its own without manipulation of a driver or passenger. An autonomous driving system refers to a system for monitoring and controlling the autonomous vehicle to drive on its own. There is need of a technology for enabling an autonomous vehicle to avoid a predicted accident through avoidance driving when there is a section where the accident is predicted to occur in a driving route based on comparison with data on a past accident.

### SUMMARY

An aspect provides a technology for preventing an accident that is predicted based on a correspondence relationship between history information associated with a past accident cause for at least one other vehicle having driven in a specific section and information acquired from a vehicle driving in the specific section. However, the technical goal of the present disclosure is not limited thereto, and other technical goals may be inferred from the following embodiments.

According to an aspect, there is provided a method for controlling a vehicle in a computing device, the method including acquiring driving information and sensing information from the vehicle driving in a specific section, identifying a correspondence relationship between history information associated with a past accident cause for at least one other vehicle having driven in the specific section and the acquired information, and generating a control signal for controlling the vehicle based on the identified correspondence relationship.

According to another aspect, there is also provided a method for controlling a vehicle in a computing device, the method including acquiring driving information and sensing information from the vehicle in a specific section, receiving a control signal generated based on a correspondence relationship between history information associated with a past accident cause for at least one other vehicle having driven in the specific section and the acquired information, and driving in accordance with the control signal.

According to another aspect, there is also provided a vehicle comprising: a processor configured to control the vehicle to drive in accordance with a control signal generated based on a correspondence relationship between history information associated with a past accident cause for at least one other vehicle having driven in a specific section and an acquired information; and a communicator configured to receive information associated with the control signal.

According to an aspect, wherein: the past accident cause comprises at least one of the following: arrangement information of vehicles associated with a past accident, road state information of the specific section associated with the past accident, environment information associated with the past accident, and driving information of the at least one other vehicle associated with the past accident, and the control signal comprises control information for controlling the vehicle to drive in accordance with a defensive driving maneuver or alternative route to avoid an accident predicted to occur in a virtual collision route.

According to an aspect, wherein the wherein: the control information associated with the defensive driving maneuver or alternative route is determined in consideration of information on a visible region and information on a non-visible region, and the information on the visible region is determined in consideration of driving information and sensing information acquired from the vehicle, and the information on the non-visible region may be determined in consideration of driving information and sensing information acquired from an adjacent vehicle driving in the specific section.

Details of other embodiments are included in the detailed description and the accompanying drawings.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an AI device 100 according to an embodiment of the present disclosure.

FIG. 2 illustrates an AI server 200 according to an embodiment of the present disclosure.

FIG. 3 illustrates an AI system 1 according to an embodiment of the present disclosure.

FIG. 4 illustrates a block diagram illustrating a configuration of a wireless communication system to which methods proposed in the present disclosure are applicable.

FIG. 5 illustrates an example of physical channels used in a 3GPP system and general signal transmission.

FIG. 6 illustrates an example of basic operations of an autonomous vehicle and a 5G network in a 5G communication system.

FIG. 7 illustrates an example of basic operations between vehicles using 5G communication.

FIG. 8 is a control block diagram of an autonomous vehicle according to an embodiment

FIG. 9 is an example of vehicle-to-everything (V2X) communication to which the present disclosure is applicable.

FIG. 10 is a diagram illustrating a relationship between a server and vehicles according to an embodiment,

FIG. 11 is a diagram illustrating an example in which a past accident occurs in the embodiment.

FIG. 12 is a view illustrating vehicles driving in an accident section according to an embodiment.

FIG. 13 is a diagram illustrating an example of avoidance driving according to an embodiment.

FIG. 14 is a view illustrating how to control an arrangement relationship between vehicles according to an embodiment.

FIG. 15 is a flowchart of a method for controlling a vehicle according to an embodiment.

### DETAILED DESCRIPTION

Exemplary embodiments of the present disclosure are described in detail with reference to the accompanying drawings.

Detailed descriptions of technical specifications well-known in the art and unrelated directly to the present disclosure may be omitted to avoid obscuring the subject matter of the present disclosure. This aims to omit unnecessary description so as to make clear the subject matter of the present disclosure.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operations to be performed on the computer or other programmable apparatus to produce a computer implemented process such that the instructions which are executed on the computer or other programmable apparatus provide operations for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

In addition, a controller mentioned in the embodiments may include at least one processor that is operated to control a corresponding apparatus.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function may be used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

A vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

In this case, an autonomous vehicle may be seen as a robot having an autonomous driving function,

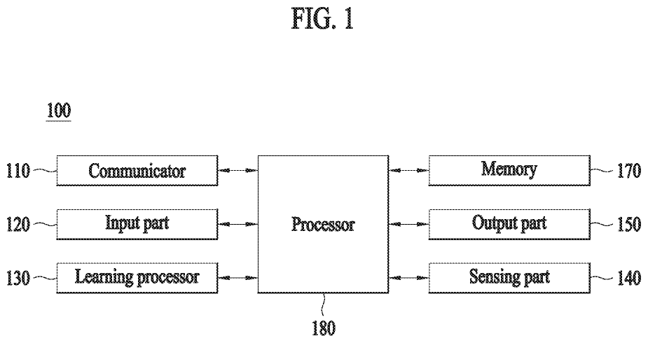

FIG. 1 illustrates an AI device 100 according to an embodiment of the present disclosure.

The AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, a terminal 100 may include a communicator 110, an input part 120, a learning processor 130, a sensing part 140, an output part 150, a memory 170, and a processor 180, for example.

The communicator 110 may transmit and receive data to and from external devices, such as other AI devices 100a to 100e and an AI server 200, using wired/wireless communication technologies. For example, the communicator 110 may transmit and receive sensor information, user input, learning models, and control signals, for example, to and from external devices.

In this case, the communication technology used by the communicator 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFD), infrared data association (IrDA), ZigBee, or near field communication (NFC).

The input part 120 may acquire various types of data.

In this case, the input part 120 may include a camera for the input of an image signal, a microphone for receiving an audio signal, and a user input part for receiving information input by a user, for example. Here, the camera or the microphone may be handled as a sensor, and a signal acquired from the camera or the microphone may be referred to as sensing data or sensor information.

The input part 120 may acquire, for example, input data to be used when acquiring an output using learning data for model learning and a learning model. The input part 120 may acquire unprocessed input data, and in this case, the processor 180 or the learning processor 130 may extract an input feature as pre-processing for the input data.

The learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

In this case, the learning processor 130 may perform Al processing along with a learning processor 240 of the AI server 200.

In this case, the learning processor 130 may include a memory integrated or embodied in the AI device 100. Alternatively, the learning processor 130 may be realized using the memory 170, an external memory directly coupled to the AI device 100, or a memory held in an external device.

The sensing part 140 may acquire at least one of internal information of the AI device 100 and surrounding environmental information and user information of the AI device 100 using various sensors.

In this case, the sensors included in the sensing part 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

The output part 150 may generate, for example, a visual output, an auditory output, or a tactile output.

In this case, the output part 150 may include, for example, a display that outputs visual information, a speaker that outputs auditory information, and a haptic module that outputs tactile information.

The memory 170 may store data which assists various functions of the AI device 100. For example, the memory 170 may store input data acquired by the input part 120, learning data, learning models, and learning history, for example.

The processor 180 may determine at least one executable operation of the AI device 100 based on information determined or generated using a data analysis algorithm or a machine learning algorithm. Then, the processor 180 may control constituent elements of the AI device 100 to perform the determined operation.

To this end, the processor 180 may request, search, receive, or utilize data of the learning processor 130 or the memory 170, and may control the constituent elements of the AI device 100 so as to execute a predictable operation or an operation that is deemed desirable among the at least one executable operation.

In this case, when connection of an external device is necessary to perform the determined operation, the processor 180 may generate a control signal for controlling the external device and may transmit the generated control signal to the external device.

The processor 180 may acquire intention information with respect to user input and may determine a user request based on the acquired intention information.

In this case, the processor 180 may acquire intention information corresponding to the user input using at least one of a speech to text (STT) engine for converting voice input into a character string and a natural language processing (NLP) engine for acquiring natural language intention information.

In this case, at least a part of the STT engine and/or the NLP engine may be configured with an artificial neural network learned according to a machine learning algorithm. Then, the SIT engine and/or the NLP engine may have learned by the learning processor 130, may have learned by the learning processor 240 of the AI server 200, or may have learned by distributed processing of the processors 130 and 240.

The processor 180 may collect history information including, for example, the content of an operation of the AI device 100 or feedback of the user with respect to an operation, and may store the collected information in the memory 170 or the learning processor 130, or may transmit the collected information to an external device such as the AI server 200. The collected history information may be used to update a learning model.

The processor 180 may control at least some of the constituent elements of the AI device 100 in order to drive an application program stored in the memory 170. Moreover, the processor 180 may combine and operate two or more of the constituent elements of the AI device 100 for the driving of the application program.

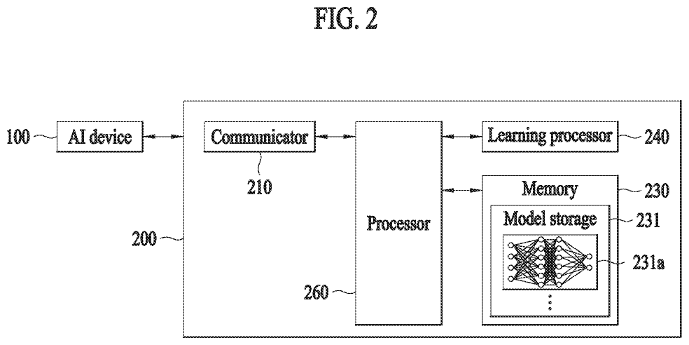

FIG. 2 illustrates the AI server 200 according to an embodiment of the present disclosure.

Referring to FIG. 2, the AI server 200 may refer to a device that causes an artificial neural network to learn using a machine learning algorithm or uses the learned artificial neural network. Here, the AI server 200 may be constituted of multiple servers to perform distributed processing, and may be defined as a 5G network. In this case, the AI server 200 may be included as a constituent element of the AI device 100 so as to perform at least a part of Al processing together with the AI device 100.

The AI server 200 may include a communicator 210, a memory 230, a learning processor 240, and a processor 260, for example.

The communicator 210 may transmit and receive data to and from an external device such as the AI device 100.

The memory 230 may include a model storage 231. The model storage 231 may store a model (or an artificial neural network) 231a which is learning or has learned via the learning processor 240.

The learning processor 240 may cause the artificial neural network 231a to learn learning data. A learning model may be used in the state of being mounted in the AI server 200 of the artificial neural network, or may be used in the state of being mounted in an external device such as the AI device 100.

The learning model may be realized in hardware, software, or a combination of hardware and software. In the case in which a part or the entirety of the learning model is realized in software, one or more instructions constituting the learning model may be stored in the memory 230.

The processor 260 may deduce a result value for newly input data using the learning model, and may generate a response or a control instruction based on the deduced result value.

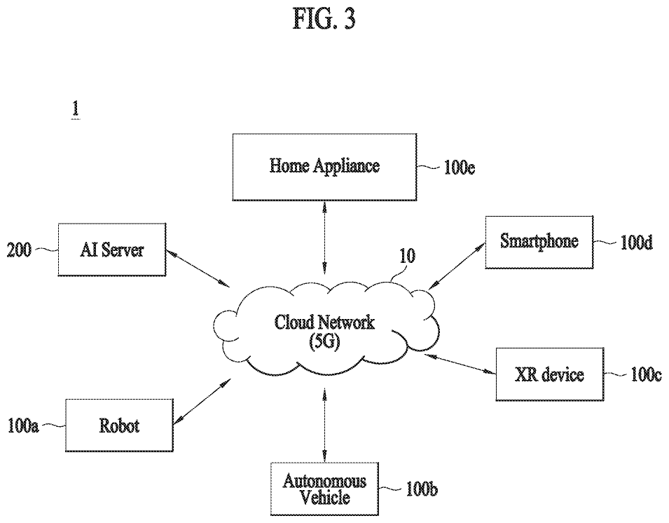

FIG. 3 illustrates an AI system 1 according to an embodiment of the present disclosure.

Referring to FIG. 3, in the AI system 1, at least one of an AI server 200, a robot 100a, an autonomous vehicle 100b, an XR device 100c, a smart phone 100d, and a home appliance 100e is connected to a cloud network 10. Here, the robot 100a, the autonomous vehicle 100b, the XR device 100c, the smart phone 100d, and the home appliance 100e, to which AI technologies are applied, may be referred to as the AI devices 100a to 100e.

The Cloud network 10 may constitute a part of a cloud computing infra-structure, or may mean a network present in the cloud computing infra-structure. Here, the cloud network 10 may be configured using a 3G network, a 4G or long term evolution (LTE) network, or a 5G network, for example.

That is, the respective devices 100a to 100e and 200 constituting the AI system 1 may be connected to each other via the cloud network 10. In particular, the respective devices 100a to 100e and 200 may communicate with each other via a base station, or may perform direct communication without the base station.

The AI server 200 may include a server which performs AI processing and a server which performs an operation with respect to big data.

The AI server 200 may be connected to at least one of the robot 100a, the autonomous vehicle 100b, the XR device 100c, the smart phone 100d, and the home appliance 100e, which are AI devices constituting the AI system 1, via the cloud network 10, and may assist at least a part of AI processing of the connected AI devices 100a to 100e.

In this case, instead of the AI devices 100a to 100e, the AI server 200 may cause an artificial neural network to learn according to a machine learning algorithm, and may directly store a learning model or may transmit the learning model to the AI devices 100a to 100e.

In this case, the AI server 200 may receive input data from the AI devices 100a to 100e, may deduce a result value for the received input data using the learning model, and may generate a response or a control instruction based on the deduced result value to transmit the response or the control instruction to the AI devices 100a to 100e.

Alternatively, the AI devices 100a to 100e may directly deduce a result value with respect to input data using the learning model, and may generate a response or a control instruction based on the deduced result value.

Hereinafter, various embodiments of the AI devices 100a to 100e, to which the above-described technology is applied, will be described. Here, the AI devices 100a to 100e illustrated in FIG. 3 may be specific embodiments of AI device 100 illustrated in FIG. 1.

The autonomous vehicle 100b may be realized into a mobile robot, a vehicle, or an unmanned aerial vehicle, for example, through the application of AI technologies.

The autonomous vehicle 100b may include an autonomous driving control module for controlling an autonomous driving function, and the autonomous driving control module may mean a software module or a chip realized in hardware. The autonomous driving control module may be a constituent element included in the autonomous vehicle 100b, but may be a separate hardware element outside the autonomous vehicle 100b so as to be connected to the autonomous vehicle 100b.

The autonomous vehicle 100b may acquire information on the state of the autonomous vehicle 100b using sensor information acquired from various types of sensors, may detect (recognize) the surrounding environment and an object, may generate map data, may determine a movement route and a driving plan, or may determine an operation.

Here, the autonomous vehicle 100b may use sensor information acquired from at least one sensor among a lidar, a radar, and a camera in the same manner as the robot 100a in order to determine a movement route and a driving plan.

In particular, the autonomous vehicle 100b may recognize the environment or an object with respect to an area outside the field of vision or an area located at a predetermined distance or more by receiving sensor information from external devices, or may directly receive recognized information from external devices.

The autonomous vehicle 100b may perform the above-described operations using a learning model configured with at least one artificial neural network. For example, the autonomous vehicle 100b may recognize the surrounding environment and the object using the learning model, and may determine a driving line using the recognized surrounding environment information or object information. Here, the learning model may be directly learned in the autonomous vehicle 100b, or may be learned in an external device such as the AI server 200.

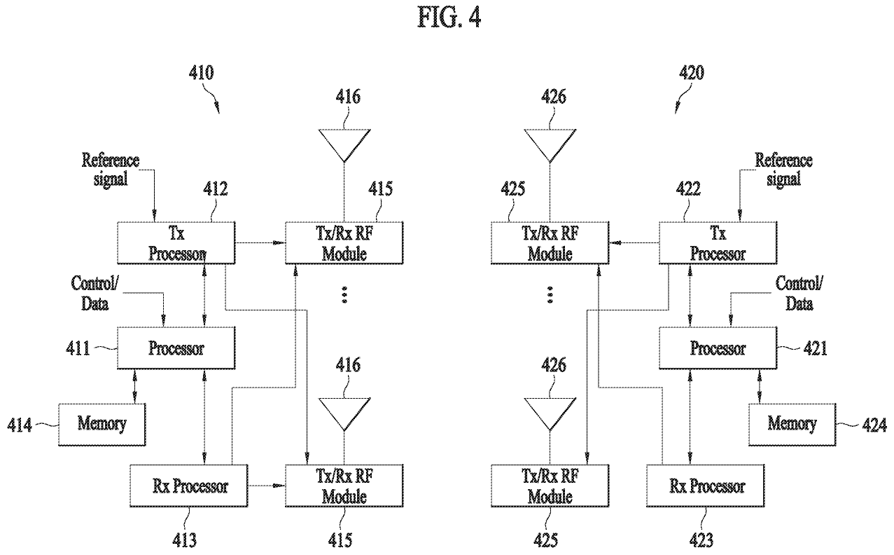

FIG. 4 illustrates a block diagram illustrating a configuration of a wireless communication system to which methods proposed in the present disclosure are applicable.

Referring to FIG. 4, a device including an autonomous driving module (e.g., an autonomous driving device) may be defined as a first communication device 410, and a processor 411 may perform detailed operations of autonomous driving. Here, the autonomous driving device may include an autonomous vehicle. A 5G network including another vehicle in communication with the autonomous driving device may be defined as a second communication device 421, and a processor 421 may perform detailed autonomous driving operation. Alternatively, the 5G network may be referred to as a first communication device and the autonomous driving device may be referred to as a second communication device. For example, the first communication device or the second communication device may be a network node, a transmitting terminal, a receiving terminal, a wireless device, a wireless communication device, an autonomous driving device, etc.

For example, a terminal or a user equipment (UE) may include a vehicle, a mobile phone, a smart phone, a laptop computer, a digital broadcast terminal, a personal digital assistant (FDA), a portable multimedia player (PMP), a navigation system, a slate PC, a tablet PC, an ultrabook, a wearable device (e.g., a smartwatch, a smart glass, a head-mounted display (HMD), etc. Referring to FIG. 4, the first communication device 410 and the second communication device 420 includes processors 411 and 421, memories 414 and 424, one or more TX/RX radio frequency (RF) modules 415 and 425, Tx processors 412 and 422, Rx processors 413 and 423, and antennas 416 and 426. The Tx/RX modules may be referred to as transceivers. Each Tx/Rx module 415 transmits a signal through an antenna thereof. The processor implements the aforementioned functions, processes, and/or methods. The processor 421 may be associated with the memory 424 for storing program codes and data. The memory may be referred to as a computer readable medium. More specifically, in DL (communication from the first communication device to the second communication), the TX processor 412 implements various signal processing functions for the L1 layer (that is, physical layer). The RX processor implements various signal processing function for the L1 layer (that is, physical layer).

UL (communication from the second communication device to the first communication device) is performed in the first communication device 410 in a manner similar to the foregoing description regarding a receiver function in the second communication device 420. Each Tx/Rx module 425 receives a signal through an antenna 426 thereof. Each Tx/Rx module provides an RF carrier and information to the RX processor 423. The processor 421 may be associated with the memory 424 for storing program codes and data. The memory may be referred to as a computer readable medium.

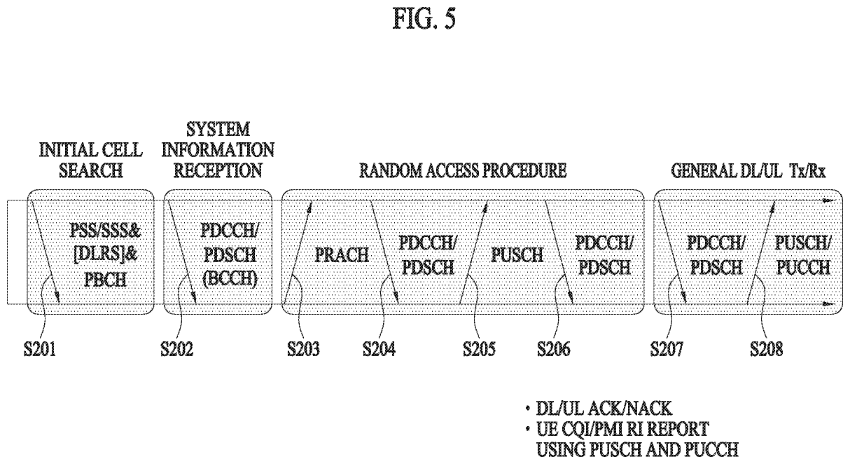

FIG. 5 illustrates an example of physical channels used in the 3GPP system and general signal transmission. In a wireless communication system, a UE receives information from a base station (BS) through a downlink (DL), and also transmits information to the BS through an uplink (UL). Examples of information transmitted from or received in the BS and the UE include data and various kinds of control information, and various physical channels exist depending on a type and usage of the information transmitted from or received in the BS and the UE.

When powered on or when a UE initially enters a cell, the UE performs initial cell search involving synchronization with a BS in operation S101. For initial cell search, the UE synchronizes with the BS and acquire information such as a cell Identifier (ID) by receiving a primary synchronization channel (P-SCH) and a secondary synchronization channel (S-SCH) from the BS. Then the UE may receive broadcast information from the cell on a physical broadcast channel (PBCH). In the meantime, the UE may identify a downlink channel status by receiving a downlink reference signal (DL RS) during initial cell search.

After initial cell search, the UE may acquire more specific system information by receiving a physical downlink control channel (POOCH) and receiving a physical downlink shared channel (PDSCH) based on information of the POOCH in operation S102.

Meanwhile, if the UE initially accesses the BS or if there is no radio resource signal transmission, the UE may perform a random access procedure (RACH) to access the BS in operation S203 to S266. To this end, the UE may transmit a specific sequence through a physical random access channel (PRACH) as a preamble in operations S203 and S205) and receive a response message to the preamble through the POOCH and the PDSCH associated with the PDCCH. In the case of a contention-based random access procedure, the UE may additionally perform a contention resolution procedure in operation S206

After the foregoing procedure, the UE may receive a PDCCH/PDSCH in operation S207 and transmit a physical uplink shared channel (PUSCH)/physical uplink control channel (PUCCH) in operation S208, as a general downlink/uplink signal transmission procedure. In particular, the UE may receive downlink control information (DC) through the POOCH. Here, the DCI may include control information such as resource allocation information for the UE and a different format may be applied to the DCI according to a purpose of use.

Meanwhile, control information transmitted from the UE to the BS or received by the UE from the BS through an uplink may include uplink/downlink acknowledgement/negative-acknowledgement (ACK/NACK) signal, a channel quality indicator (CQI), a precoding matrix index (PMI), a rank indicator (RI), etc. The UE may transmit control information such as the aforementioned CQI/PMI/RI and the like through the PUSCH and/or PUCCH.

### A. Beam Management (BM) Procedure of the 5G Communication System

The BM procedure may be classified into (1) a DL BM process using an SSB or a CSI-RS and (2) a UL BM process using a sounding reference signal (SRS). In addition, each BM procedure may include Tx beam sweeping for determining a Tx beam and Rx beam sweeping for determining an Rx beam.

A DL BM procedure using an SSB will be described.

Setting a beam report using an SSB may be performed upon channel state information (CSI)/beam setting in an RRC_CONNECTED state.
An UE receives CSI-ResourceConig IE, including a CSI-SSB-ResourceSetList for SSB resources to be used for BM, from a BS. The CSI-SSB-ResourceSetList, which is an RRC parameter, represents a list of SSB resources to be used in a single resource set for beam management and beam reporting. Here, the SSB resource set may be set to be {SSBx1, SSBx2, SSBx3, SSBx4, ˜}. An SSB index may be defined as 0 to 63.
The UE receives signals on the SSB resources from the BS based on the CSI-SSB-ResourceSetList.
When CSI-RS reportConfig associated with reporting an SS/PBCH Resource Block Indicator (SSBRI) and reference signal received power (RSRP), the UE reports the best SSBRI and RSRP corresponding thereto to the BS. For example, reportQuantity of the CSI-RS reportConfig IE is set to “ssb-Index-RSRP”, the UE reports the best SSBRI and the RSRP corresponding to the best SSBRI to the BS.

When a CSI-RS resource is set to an OFDM symbol(s) identical to the SSB is set and when “QCL-TypeD” is applicable, the UE may assume that the CSI-RS and the SSB are quasi co-located (QCL) with each other in view of “QCL-TypeD”. Here, the QCL-typeD may mean that antenna ports are QCL with each other in view of a spatial Rx parameter. When the UE receives signals from a plurality of DL antenna ports in a QCL-TypeD relationship, there is no problem even though the same reception beam is applied.

Next, a DL BM procedure using a CSI-RS will be described.

An Rx beam determining (or refining) procedure performed by a UE using a CSI-RS, and a Tx beam sweeping procedure performed by a BS will be described sequentially. In the Rx beam determining procedure performed by the UE, a repetition parameter is set to “ON.” In the Tx beam sweeping procedure performed by the BS, the repetition parameter is set to “OFF.”

First, the Rx beam determining procedure performed by the UE will be described.
The UE receives an NZP CSI-RS resource set IE, including an RRC parameter regarding “repetition”, from a BS through RRC signaling. Here, the RRC parameter “repetition” is set to “ON.”
The UE repeatedly receives, from different OFDM symbols through the same Tx beam (or a DL spatial domain transmission filter), signals on a resource(s) in the CSI-RS resource set of which the RRC parameter “repetition” is set to “ON”.
The UE determines an RX beam of its own.
The UE omits CSI reporting. That is, when the RRC parameter “repetition” is set to “ON”, the UE may omit CSI reporting.

Next, the Tx beam determining procedure performed by the BS will be described.
The UE receives an NZP CSI-RS resource set IE including an RRC parameter regarding “repetition” from the BS through RRC signaling. Here, the RRC parameter “repetition” is set to “OFF” and associated with the Tx beam sweeping procedure performed by the BS.
The UE receives, through different Tx beams (or a DL spatial domain transmission filter, signals on resources in a CSI-RS resource set of which the RRC parameter “repetition’ is set to “OFF.”
The UE selects (or determines) the best beam.
The UE reports an ID (e.g., CSI-RS resource indicator (CRI)) for the selected beam and relevant quality information (e.g., RSRP) to the BS. That is, when a CSI-RS is transmitted for BM, the UE reports CRI and RSRP regarding the CRI to the BS.

Next, a UL BM procedure using a sounding reference signal (SRS) will be described.
The UE receives, from the BS, RRC signaling (e.g., an SRS-Config IE) including a usage parameter set to “beam management” (RRC parameter). The SRS-Config IE is used for SRS transmission setting. The SRS-Config IE includes a list of SRS-resources and a list of SRS-ResourceSets. Each SRS resource set means a set of SRS-resources.
The UE determines Tx beamforming for an SRS resource to be transmitted based on SRS-SpatialRelation Info included in the SRS-Config IE. Here, the SRS-SpatialRelation Info is set for each SRS resource and indicates whether the same beamforming used in an SSB, a CSI-RS, or an SRS is to be applied for each SRS.
If SRS-SpatialRelationInfo is set in an SRS resource, the SRS resource is applied by applying the same beamforming used in the SSB, the CSI-RS, or the SRS. If SRS-SpatialRelationInfo is not set in the SRS resource, the UE arbitrarily determines Tx beamforming and transmits the SRS through the determined Tx beamforming.

Next, a beam failure recovery (BFR) procedure will be described.

In a beam-formed system, a radio link failure (RLF) may frequently occur due to rotation, movement, or beamforming blockage of the UE. In order to prevent frequent occurrence of RLF, BFR is supported in NR. The BFR is similar to a radio link failure recovery procedure and may be supported when the UE is aware of a new candidate beam(s). In order to detect a beam failure, the BS sets beam failure detection reference signals to the UE. When the number of beam failure indications from the physical layer of the UE reaches a threshold set by RRC signaling within a period set by RRC signaling of the BS, the UE declares a beam failure. After the beam failure is detected, the UE triggers a beam failure recovery by initiating a random access process on a PCell, and performs the beam failure recovery by selecting a suitable beam (when the BS provides dedicated random access resources for certain beams, the beams are prioritized by the UE). When the random access procedure is completed, it is considered completion of the beam failure recovery.

### B. URLLC (Ultra-Reliable and Low Latency Communication)

URLLC transmission defined in NR may mean (1) a relatively low traffic volume, (2) a relatively low arrival rate, (3) an extremely low latency requirement (e.g., 0.5, 1 ms), (4) a relatively low transmission duration (e.g., 2 OFDM symbols), and (5) transmission of an emergency service/message, etc. In the case of a UL, in order to satisfy a more stringent latency requirement, multiplexing with other transmission (e.g., eMBB) scheduled prior to transmission of a specific type traffic (e.g., URLLC) may need to be performed. As one way regarding the above, information indicating that a specific resource will be preemptive may be given to a UE and the corresponding resource may be allowed to be used by an URLLC UE for UL transmission.

In NR, dynamic resource sharing between an eMBB and URLLC is supported. The eMBB and URLLC services may be scheduled on non-overlapping time/frequency resources, and URLLC transmission may be performed on resources scheduled for ongoing eMBB traffic. An eMBB UE may not be allowed to know whether PDSCH transmission by the corresponding UE is partially punctured, and the UE may not be allowed to decode a PDSCH due to corrupted coded bits. Given the above, the NR provides a preemption indication. The preemption indication may be referred to as an interrupted transmission indication.

Regarding the preemption indication, the UE receives a DownlinkPreemption IE through RRC signaling from the BS. When the DownlinkPreemption IE is received, the UE is set using an INT-RNTI, provided by a parameter int-RNTI in the DownlinkPreemption IE, in order to monitor a PDCCH that conveys DCI format 2_1. The UE is set with a set of serving cells according to an INT-ConfigurationPerServing Cell including a set of serving cell indices additionally provided by a servingCellID, and may be set with a set of locations for fields in DCI format 2_1 according to positionInDCI, may be set with an information payload size for DCI format 2_1 according to dci-PayloadSize, and may be set with an indication granularity of time-frequency resources according to timeFrequencySect.

The UE receives the DCI format 2_1 from the BS based on the DownlinkPreemption IE.

When the UE detects DCI format 2_! For a serving cell in a set of serving cells, the UE may assume that no transmission to the UE is not performing in PRBs and symbols indicated by the DCI format 2_1 among a set of PRBs and set of symbols in the last monitoring period before a monitoring period to which the DCI format 2_1 belongs. For example, the U consider that a signal in a time-frequency resource indicated by a preemption is not DL transmission scheduled to the UE, and then the Ue decodes data based on signals received in other resource regions.

### C. mMTC (Massive MTC)

Massive Machine Type Communication (mMTC) is one of 5G scenarios for supporting a super connection service that indicates simultaneously communicating with a large number of UEs. In this environment, the UEs have an extremely low transmission rate and an extremely low mobility and thus perform communication intermittently. Thus, the mMTC aims to run the UEs for a long time at a low cost. Regarding mMTC technologies, 3gPP addresses MTC and narrow band (NB)-IoT.

The mMTC technologies have characteristics as follows: repetitive transmission through a PDCCH, a PUCCH, a physical downlink shared channel (PDCCH), a PUSCH, and the like; frequency hopping; retuning, a guard period, etc.

That is, repetitive transmission is performed through a PUSCH (or a PUCCH (especially a long PUCCH)) including particular information and a PDSCH (or a POOCH) including a response to the particular information. The repetitive transmission is performed through frequency hopping. For the repetitive transmission, (RF) returning from a first frequency resource to a second frequency resource is performed in a guard period. The particular information and the response to the particular information may be transmitted/received through a narrowband (e.g., 6 resource block (RB) or 1 RB).

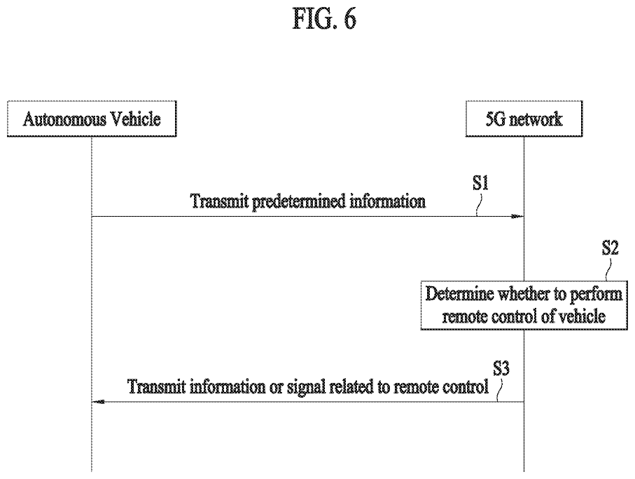

FIG. 6 illustrates an example of basic operations between an autonomous vehicle and a 5G network in a 5G communication system.

An autonomous vehicle transmits predetermined information to the 5G network in operation S1. The predetermined information may include autonomous driving-related information. The 5G network may determine whether to perform remote control of the vehicle in operation S2. Here, the 5G network may include a server or module for performing an autonomous driving-related remote control. The 5G network may transmit information (or a signal) related to the remote control to the autonomous vehicle in operation S3.

Here, application operations between the autonomous vehicle and the 5G network in the 5G communication system are as below. Hereinafter, operation of an autonomous vehicle using 5G communication will be described in detail based on FIGS. 1 and 2 and the above-described wireless communication technologies (e.g., BM procedure, URLLC, Mmtc, etc.).

First, a method described later and proposed in the present disclosure and a basic procedure of application operations applied to the eMBB technology will be described.

As shown in operations S1 and S3 of FIG. 6, in order for the autonomous vehicle to transmit and receive a signal, information, and the like with respect to the 5G network, the autonomous vehicle performs, prior to operation S1 of FIG. 6, an initial access procedure and a random access procedure with respect to the 5G network.

More specifically, the autonomous vehicle performs the initial access procedure with respect to the 5G network based on an SSB in order to acquire DL synchronization and system information. During the initial access procedure, a BM process and a beam failure recovery process may be added. In addition, while the autonomous vehicle receives a signal from the 5G network, a quasi-co location (QCL) relationship may be added.

In addition, the autonomous vehicle performs the random access procedure with respect to the 5G network in order to acquire UL synchronization and/or transmit a UL. Further, the 5G network may transmit a UL grant to schedule transmission of predetermined information to the autonomous vehicle. Accordingly, the autonomous vehicle transmits the predetermined information to the 5G network based on the UL grant. The 5G network transmits a DL grant to schedule transmission of a 5G processing result regarding the predetermined information to the autonomous vehicle. Accordingly, the 5G network may transmit remote control-related information (or signal) to the autonomous vehicle.

Next, a method proposed in the present disclosure and a basic procedure of application operations to which a URLLC technology of 5G communication is applied will be described.

As described above, after the initial access procedure and/or the random access procedure with respect to the 5G network, the autonomous vehicle may receive DownlinkPreemption IE from the 5G network. Then, based on DownlinkPreemption IE, the autonomous vehicle may receive DCI format 2_1 including a pre-emption indication from the 5G network. Then, the autonomous vehicle does not perform (or expect/assume) reception of eMBB data from a resource (a PRB and/or an OFDM symbol) indicated by the pre-emption indication. Thereafter, when there is a need to transmit predetermined information, the autonomous vehicle may receive a UL grant from the 5G network.

Next, a method hereinafter proposed in the present disclosure and a basic procedure of application operations to which the mMTC technology of 5G communication will be described.

The operations in FIG. 6 will be described mainly about part thereof that are changed upon application of the mMTC technology. In operation S1 of FIG. 6, an autonomous vehicle receive a UL grant from a 5G network in order to transmit predetermined information to a 5G network. The UL grant may include information on the repetition number of times the predetermined information is transmitted, and the predetermined information may be repeatedly transmitted based on the repetition number of times. That is, the autonomous vehicle transmits the predetermined information to the 5G network based on the UL grant. The repetition of transmission of the predetermined information is performed through frequency hopping, and first predetermined information may be transmitted from a first frequency resource and second predetermined information may be transmitted from a second frequency resource. The predetermined information may be transmitted through a narrowband of 6 resource block (RB) or 1 RB.

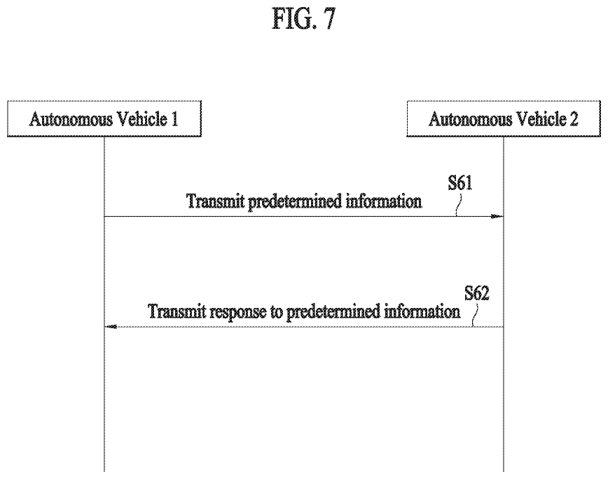

FIG. 7 illustrates an example of basic operations between vehicles using 5G communication.

A first vehicle transmits predetermined information to a second vehicle in operation S61. The second vehicle transmits a response to predetermined information to the first vehicle in operation S62.

Meanwhile, configuration of application operations between vehicles may vary depending on whether a 5G network directly (in sidelink communication transmission mode 3) or indirectly (in sidelink communication transmission mode 4) involves in resource allocation for the response to the predetermined information.

Next, application operations between vehicles through 5G communication will be described. First, a method in which the 5G network directly involves in resource allocation for signal transmission and/or reception between vehicles will be described.

The 5G network may transmit, to the first vehicle, DCI format 5A for scheduling mode-3 transmission (transmission over a physical sidelink control channel (PSCCH) and/or a physical sidelink shared channel (PSSCH)). Here, the PSCCH is a 5G physical channel for scheduling transmission of predetermined information, and the PSSCH is a 5G physical channel for transmitting the predetermined information. Then, the first vehicle transmits SCI format 1 for scheduling the transmission of the predetermined information to the second vehicle on the PSCCH. Then, the first vehicle transmits the predetermined information to the second vehicle on the PSSCH.

Next, a method in which the 5G network indirectly involves in resource allocation for signal transmission and/or reception will be described.

The first vehicle senses, on a first window, a resource for mode-4 transmission. Then, based on a result of the sensing, the first vehicle selects a resource for mode-4 transmission from a second window. Here, the first window refers to a sensing window, and the second window refers to a selection window. Based on the selected resource, the first vehicle transmits SCI format 1 for scheduling of transmission of predetermined information to the second vehicle on a PSCCH. Then, the first vehicle transmits the predetermined information to the second vehicle on a PSSCH.

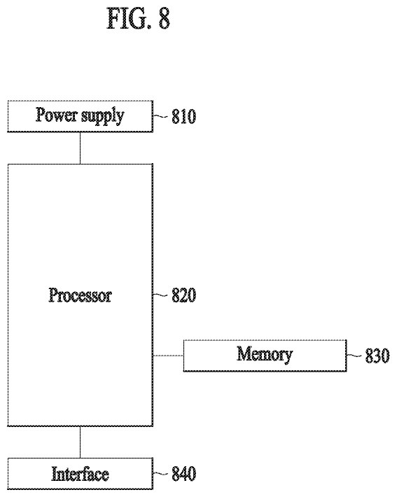

FIG. 8 is a control block diagram of an autonomous vehicle according to an embodiment.

Referring to FIG. 8, the autonomous vehicle may include a memory 830, a processor 820, an interface 840, and a power supply 810. Here, the foregoing description may apply to the memory 830, the processor 820, and the interface 840.

The memory 830 is electrically connected with the processor 820. The memory 830 may store basic data for units, control data for operation control of the units, and input/output data. The memory 830 may store data processed by the processor 820. The memory 830 may be implemented as at least one hardware element of an ROM, an ARM, an EPROM, a flash drive, or a hard drive. The memory 830 may store a variety of data for overall operation of an autonomous driving device, such as a program for processing or control of the processor 820. The memory 830 may be integrally formed with the processor 820. According to an embodiment, the memory 830 may be classified as a subordinate element of the processor 820.

The interface 840 may exchange a signal in a wired or wireless manner with at least one electronic device provided in a vehicle. The interface 840 may be formed as at least one of a communication module, a terminal, a pin, a cable, a port, a circuit, an element, or a device.

The power supply 810 may supply power to the autonomous driving device. The power supply 810 may receive power from a power source (e.g., a battery) included in the vehicle and supply the power to each unit of the autonomous driving device. The power supply 810 may operate in accordance with a control signal provided from a main ECU. The power supply 810 may include a switched-mode power supply (SMPS).

The processor 820 may be electrically connected with the memory 830, the interface 840, and the power supply 810 and exchange signals therewith. The processor may be implemented using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, and electric units for the implementation of other functions.

The processor 820 may be driven by power provided from the power supply 810. While power is supplied from the power supply 810, The processor 820 may receive data, process the data, generate a signal, and provide the signal

The processor 820 may receive information from another electronic device provided in the vehicle, and the processor may provide a control signal to another electronic device provided in the vehicle.

The autonomous driving device may include at least one printed circuit board (PCB). The memory 830, the interface 840, the power supply 810, and the processor 820 may be electrically connected with the PCB.

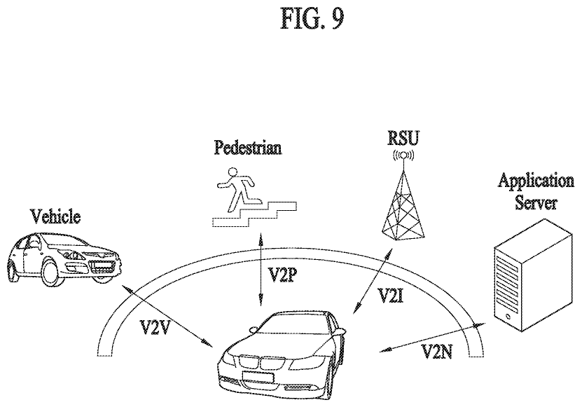

FIG. 9 is an example of vehicle-to-everything (V2X) communication to which the present disclosure is applicable.

V2X communication includes communication between a vehicle and any entity. For example, the V2X communication includes vehicle-to-vehicle (V2V) communication referring to communication between vehicles, vehicle-to-infrastructure (V2I) communication referring to communication between a vehicle and an eNB or road side unit (RSU), vehicle-to-pedestrian (V2P) communication referring to communication between a vehicle and a UE carried by a person (a pedestrian, a bicycler, a vehicle driver, or a passenger), and vehicle-to-network (V2N) communication.

The V2X communication may have the same meaning of V2X sidelink or NR V2X or may have a broader meaning including V2X sidelink or NR V2X.

The V2X communication may be applicable to various services, such as a front collision warning, an automatic parking system, a cooperative adaptive cruise control (CACC), a control loss warning, a traffic matrix warning, a vulnerable road user warning, an emergency vehicle alert, a speed warning when driving along a bent road, a road traffic control, etc.

The V2X communication may be provided through a PC5 interface or a Uu interface. In this case, in a wireless communication system that support the V2V communication, predetermined network entities for supporting communication between the vehicle and any entity may exist. For example, the network entity may be a BS (eNB), an RSU, a UE, an application server (e.g., a traffic safety server), or the like.

In addition, a UE performing the V2X communication may be not just a general handheld UE, but also a vehicle UE (V-UE), a pedestrian UE, an eNB type RSU, or a UE-type RSU, and a robot having a communication module.

The V2X communication may be performed directly between UEs or may be performed by the network entity(s). According to a method for performing the V2X communication, a V2X operation mode may be classified.

In order to prevent an operator or a third party from tracking a UE identifier in a region where V2X is supported, the V2X communication is required to support pseudonymity and privacy of a UE while a V2X application is in use.

Terms frequently used in the V2X communication are defined as below.
Road Side Unit (RSU): a road side unit (RSU) is a V2X service-capable apparatus capable of transmission and reception to and from a moving vehicle using V2I service. Furthermore, the RSU is a fixed infrastructure entity supporting a V2X application program and may exchange messages with other entities supporting a V2X application program. The RSU is a term frequently used in the existing ITS spec. The reason why this term is introduced into 3GPP spec. is for enabling the document to be read more easily in the ITS industry. The RSU is a logical entity that combines V2X application logic with the function of an eNB (called eNB-type RSU) or a UE (called UE-type RSU).
V2I Service: Type of V2X service and an entity having one side belonging to a vehicle and the other side belonging to infrastructure.
V2P Service: V2X service type in which one side is a vehicle and the other side is a device carried by a person (e.g., a portable UE carried by a pedestrian, bicycler, driver, or follow passenger).

V2X Service: 3GPP communication service type in which a transmission or reception device is related to a vehicle.

V2X enabled UE: UE supporting a V2X service.

V2V Service: Type of V2X service in which both sides of communication are vehicles.

V2V communication range: A direct communication range between two vehicles participating in V2V service.

A V2X application called vehicle-to-everything (V2X), as described above, includes the four types of (1) vehicle-to-vehicle (V2V), (2) vehicle-to-infrastructure (V2I), (3) vehicle-to-network (V2N) and (4) vehicle-to-pedestrian (V2P).

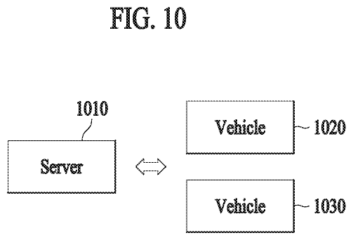

FIG. 10 is a view illustrating a server and a vehicle according to an embodiment.

According to an embodiment, a vehicle 1020 and a vehicle 1030 may communicate with a server 1010 in a wired or wireless manner while driving. The vehicle 1020 and the vehicle 1030 may communicate directly with the server 1010 or may communicate with the server using a Road Side Unit (RSU), which is infrastructure. The vehicle 1020 and the vehicle 1030 may autonomously travel on roads. When a destination of the vehicles 1020 and 1030 is input, at least one predicted route may be provided, and the vehicles 1020 and 1030 may autonomously drive on roads along the determined predicted route. In this case, an accident may repeatedly occur in a specific section within the predicted route, or an accident may occur due to a new cause. There is need of a technology for preventing an accident occurring when an autonomous vehicle travels in the specific section.

Based on data on a past accident that occurred in the specific section, history information regarding the corresponding section may be learned. Specifically, the history information may include an accident cause that includes information learned based on data on at least one other vehicle having driven in the specific section. Here, the past accident cause may correspond to a cause related to the past accident from among arrangement information of vehicles associated with a past accident, road state information of the corresponding section associated with the past accident, environment information of the corresponding section associated with the past accident, and driving information of a vehicle associated with the past accident.

Here, the arrangement information of the vehicles associated with the past accident may be information regarding an arrangement relationship between vehicles adjacent to a vehicle. Based on the arrangement information, a region not sensible to a sensor of the vehicle currently driving may be identified. A visible region may be determined in consideration of driving information and sensing information acquired from the vehicle. A non-visible region not sensible to the vehicle may be determined in consideration of driving information and sensing information acquired from an adjacent vehicle which is driving in a specific section. Based on speed/location/spacing/shape information and arrangement information of the adjacent vehicle, a region not sensible to the vehicle currently autonomously driving may be identified. For example, the adjacent vehicle may be an express bus and there may be a region not sensible to the vehicle due to a height of the express bus. In addition, the road state information may be information regarding a road, a geographical feature, a geographical object, and a traffic line in a corresponding section. For example, information regarding a pothole formed in a roadway and a height of a manhole cover height may be included in the road state information, or information regarding fading or decoloring of a traffic line may be included in the road state information. In addition, the environment information may be information regarding an environment for the vehicle currently driving. For example, the environment information may include an amount of rainfall, a degree of ponding of rain water, an amount of snowfall, the presence/absence of an icy road, a height of the icy road, a wind speed, a wind direction, etc. In addition, the driving information of the vehicle may be information on the vehicle which is now driving, and may include, for example, a speed and a location of the vehicle.

While traveling in the specific section, the vehicle 1020 may acquire at least one of the driving information or the sensing information. The driving information of the vehicle 1020 may be information regarding driving of the vehicle and may include, for example, a speed and a location of the vehicle 1020. In addition, the sensing information may be information acquired by a sensor mounted in the vehicle 1020 and may include, for example, road state information, speed/location/spacing/shape information of an adjacent vehicle, environment information, and arrangement information.

The server 1010 may receive at least one of the driving information or the sensing information from the vehicle 1020. The server 1010 may identify a correspondence relationship between history information associated with a past accident cause and the information acquired from the vehicle 1020 currently autonomously driving. Specifically, a correspondence relationship between a past accident cause and the information acquired from the vehicle 1020 driving autonomously may be identified.

In this case, when the correspondence relationship satisfies a preset criterion, an accident is predicted to occur and thus the vehicle 1020 may drive to avoid the predicted accident. The preset criterion may be determined based on statistics on the past accident, For example, if the correspondence relationship is equal to or greater than 70%, it may indicate a section in which an accident is predicted to occur, if the correspondence relationship is less than 70% and equal to or greater than 30%, it may indicate a section in which caution is required to avoid an accident, and, if the correspondence relationship is less than 30%, it may indicate a section in which safe driving is possible.

Here, the correspondence relationship may be a correspondence relationship between information acquired from the vehicle 1020 and a past accident cause. Specifically, a correspondence relationship between arrangement information of vehicles associated with a past accident and arrangement information associated with the vehicle 1020 currently autonomously driving may be determined. A correspondence relationship between road state information associated with the past accident and road state information associated with the vehicle 1020 currently autonomously driving may be determined. A correspondence relationship between environment information associated with the past accident and environment information associated with the vehicle 1020 currently autonomously driving may be determined. A correspondence relationship between driving information associated with the past accident and driving information associated with the vehicle 1020 currently autonomously driving may be determined.

When a determined correspondence relationship satisfies a preset criterion and thus an accident is predicted to occur, at least one past accident cause related to the predicted accident may be identified. The server 1010 may determine a defensive driving maneuver and an alternative route to avoid an accident predicted for each past accident cause. If an accident is predicted to occur due to a combination of past accident causes, at least one defensive driving maneuver or alternative route may be determined to avoid the predicted accident. The defensive driving maneuver or alternative route may be determined in consideration of not just driving information and sensing information acquired from the vehicle 1020, but also driving information and sensing information acquired from an adjacent vehicle traveling in a corresponding section.

In this case, a virtual collision route may be determined by a combination of at least one past accident cause related to the predicted accident. The virtual collision route may be a route in which the accident is predicted to occur when the vehicle 1020 is driving along the virtual collision route. The virtual collision route determined by a combination of past accident causes may include at least one path.

A defensive driving maneuver and an alternative route may be determined in consideration of the virtual collision route. In addition, a control signal for the vehicle, which is determined by a combination of the defensive driving maneuver and the alternative route, may be determined by a combination for reducing an accident occurrence probability. Specifically, when a plurality of defensive driving maneuvers or alternative routes is identified, the vehicle 1020 currently autonomously driving may drive in accordance with a control signal by which an accident occurrence probability is reduced.

The accident occurrence probability may be a probability of a predicted accident to occur when the vehicle drives. When there is a plurality of combinations of at least one defensive driving maneuver or alternative route, the accident occurrence probability may be probabilities respectively corresponding to the plurality of combinations of at least one defensive driving maneuver or alternative route. When information capable of being used to determine a defensive driving maneuver or an alternative route is acquired or possible to be acquired while the vehicle drives, the defensive driving maneuver or the alternative route may be determined in consideration of the information. Specifically, when a type of information to be additionally acquired and a probability of such information to be additionally acquired are taken into consideration, at least one defensive driving maneuver or alternative route may be modified, and an accident occurrence probability corresponding to the modified defensive driving maneuver or alternative route may be reduced. The server 1010 may generate a control signal based on a combination of a defensive driving maneuver or alternative route having the lowest accident occurrence probability, and transmit the generated control signal to the vehicle 1020.

When the accident occurrence probability in accordance with the control signal determined by the combination of the defensive driving maneuver or alternative route does not satisfy a predetermined criterion, the server 1010 may control driving of at least one other vehicle driving in a specific section. Specifically, when the accident occurrence probability does not satisfy the predetermined criterion and thus an accident of the vehicle 1020 is predicted to occur, the server 1010 may control an adjacent vehicle or platooning vehicle in the surroundings of the vehicle 1020. When the adjacent vehicle or platooning vehicle is controlled, a control signal may be re-determined in consideration of a changed situation and the vehicle 1020 may autonomously drive in accordance with the re-determined control signal.

History information may be updated in consideration of driving of the vehicle 1020. The vehicle 1030 driving in a lane in which the vehicle 1020 is driving may drive in a corresponding section using the updated history information.

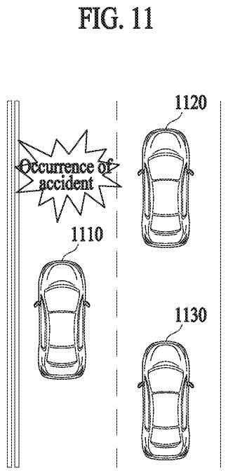

FIG. 11 is a view illustrating an example of occurrence of a past accident according to an embodiment.

A past accident may occur while a vehicle 1110 drives. In this case, a past accident cause related to the past accident of the vehicle 1110 may be analyzed. Specifically, a past accident cause related to the past accident from among an arrangement relationship of vehicles associated with the past accident, road state information of a section associated with the past accident, environment information associated with the past accident, and driving information of a vehicle associated with the past accident may be analyzed.

Here, the arrangement relationship of the vehicles may include arrangement information regarding a vehicle 1120 and a vehicle 1130 which are driving in the vicinity of the vehicle 1110. In this case, relevant information regarding size, shape, spacing, location, and speed of the vehicle 1110 and the adjacent vehicles 1120 and 1130 may be used together. Through the arrangement relationship between the vehicles, a visible region sensible to the vehicle 1110 and a non-visible region not sensible to the vehicle 1110 may be identified. If an accident occurred in the past due to the region not sensible to the vehicle 1110, an arrangement relationship between vehicles may be a past accident cause. History information may be learned based on the arrangement relationship between the vehicles.

In addition, the road state information may include information regarding a road, a geographical feature, a geographical object, and a traffic line of a corresponding section associated with the past accident. For example, the road state information may include information regarding a loss of a manhole cover, a pothole caused by denting a road (a location, a size, a depth, etc.), a height of a manhole cover raised over a road surface, a faded traffic line, decoloring of a traffic line, a guardrail height, destruction of a guardrail, a guardrail material, etc. When an accident occurs as the vehicle 1110 collides with a guardrail due to a pothole formed in a road surface, the road condition information may correspond to a past accident cause. History information may be learned based on the road state information that corresponds to the past accident cause.

In addition, the environment information may include information regarding an environment of a corresponding section associated with the past accident. For example, the environment information may include an amount of rainfall, a degree of ponding of rain water, an amount of snowfall, the presence/absence of an icy road, size and thickness of the icy road, a wind speed, a wind direction, etc. When an accident occurs as the vehicle 1110 collides with a guardrail or the vehicle 1120 due to slipping on an icy road, the environment information may correspond to a past accident cause. History information may be learned based on the environment information that corresponds to the past accident cause.

In addition, the driving information of the vehicle may be information associated with driving of the vehicle currently driving, and the driving information may include, for example, a speed and a location of the vehicle. When an accident occurs as it is hard to control the vehicle 1110 due to speeding, the driving information may correspond to a past accident cause. History information may be learned based on the driving information that corresponds to the past accident cause.

In addition, the past accident may occur due to a combination of multiple past accident causes. For example, while a speeding vehicle 1110 drives across an icy road, the vehicle 1110 may be out of control and an accident may occur. In this case, the environment information and the driving information may correspond to a past accident cause.

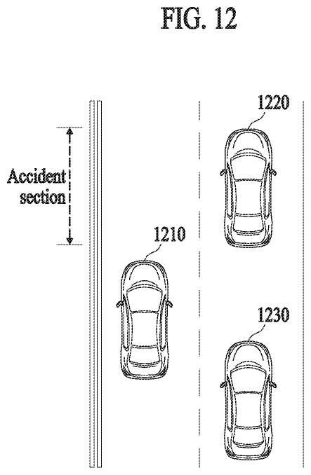

FIG. 12 is a view illustrating vehicles driving in an accident section according to an embodiment.

An accident section may be a section in which an accident occurred in the past. At least one predicted route to a destination of a vehicle 1210 driving autonomously may be found, and the accident section may be included in a selected predicted route when the vehicle 1210 drives along the selected predicted route. History information corresponding to the accident section may be learned based on a past accident cause.

At least one of driving information or sensing information acquired from the vehicle 1210 may be transmitted to a server. The server may identify a correspondence relationship between the received information and learned history information.

When a correspondence relationship between the received information and a past accident cause satisfies a preset criterion, a virtual collision route may be determined. Here, the virtual collision route may be a virtual route in which an accident is predicted to occur when the vehicle drives along the virtual collision route, and the virtual collision route may be determined based on routes that satisfy the preset criterion. For example, when slipping on an icy road in a corresponding accident section is a past accident cause, a correspondence relationship to the past accident cause may satisfy 70%, which is a preset first criterion, based on driving information and sensing information of the vehicle 1210. In this case, the route along which the vehicle 1210 drives may correspond to a virtual collision route, and the server may identify a defensive driving maneuver or alternative route to avoid an accident.

The preset criterion may be a value determined based on statistics. When the preset first criterion is satisfied, it may indicate a section in which an accident is predicted to occur. When a preset second criterion is satisfied, it may indicate a section in which caution is required to avoid an accident. When the preset second criterion is not satisfied, it may indicate a section in which safe driving is possible. Here, the section in which caution is required to avoid an accident may be changed to a section in which an accident is predicted to occur or a section in which safe driving is possible. For example, even in a case where the current correspondence relationship is 40%, an accident with a vehicle driving in a next lane may be predicted to occur due to a pothole formed in the next lane. In this case, the vehicle driving in the next lane and the pothole may be identified as past accident causes.

A defensive driving maneuver or alternative route may be determined in consideration of not just driving information and sensing information acquired from the vehicle, but also driving information and sensing information acquired from an adjacent vehicle driving in a corresponding section. The defensive driving maneuver may be a driving method performed by the vehicle to avoid an accident. The defensive driving maneuver may include acceleration/deceleration, stopping, and lane change, and the alternative route may include a different route to avoid an accident, rather than a virtual collision route. For example, when an accident is predicted to occur due to an icy road, the vehicle 1210 may perform a defensive driving maneuver of reducing a speed of the vehicle 1210 or of making a lane change to a lane in which there is no icy road. In another example, when an accident between the vehicle 1210 and a vehicle 1220 is predicted to occur due to an arrangement relationship of the vehicles 1210 and 1220, the vehicle 1210 may decelerate and drive behind a vehicle 1230, so that the accident may be avoided.

In some implementations, when safe driving is estimated not possible even if the vehicle 1210 drives in accordance with a defensive driving maneuver or alternative route, driving of other vehicles 1220 and 1230 driving in a section in which the vehicle 1210 is driving may be controlled. When the driving of other vehicles 1220 and 1230 is controlled, the defensive driving maneuver or alternative route of the vehicle 1210 may be reset in consideration of a changed situation. Driving in accordance with the reset defensive driving maneuver or alternative route may be estimated as safe driving. Specifically, when it is estimated that safe driving is not possible despite the driving in accordance with the defensive driving maneuver or alternative route of the vehicle 1210, the server may control driving of other vehicles 1220 and 1230, for example, location/speed/spacing of other vehicles 1220 and 1230. For example, when spacing between other vehicles 1220 and 1230 is controlled, a defensive driving maneuver or alternative route estimated as enabling safe driving may be reset in consideration of a changed situation.

In some implementations, when a subsequent vehicle is driving along the same route of the vehicle 1210, whether an accident occurs may be monitored. In this case, the same virtual collision route is generated for both the subsequent vehicle and the vehicle 1210, and the subsequent vehicle, unlike the vehicle 1210, does not drive in accordance with a defensive driving maneuver or alternative route. Nonetheless, the subsequent vehicle may not meet with an accident. When an accident does not occur, a virtual collision route determined by a combination of past accident causes may be an erroneously estimated route. For example, in a case where an arrangement relationship between vehicles is a past accident cause and a virtual collision route is identified based on the past accident cause, if a subsequent vehicle does not meet with an accident, the arrangement relationship between vehicles may be an erroneously estimated past accident cause.

A different past accident cause except for the erroneously estimated past accident cause may be determined. Specifically, a past accident cause from among at least one past accident cause used to generate a virtual collision route, except for the erroneously estimated past accident cause, may be used to update history information. For example, in a case i) where an accident of a vehicle 1 is predicted to occur in consideration of an arrangement relationship between the vehicle 1 and an adjacent vehicle in a specific section and the presence of an icy road and in a case ii) where an accident of a vehicle 2 driving later in the same section is predicted to occur in consideration of a speed of the vehicle 2 and the presence of an icy road, a past accident cause may be determined as the icy road. However, when no accident occurs in the corresponding section, the icy road may be an erroneously estimated past accident cause, and a different past accident cause such as an arrangement relationship between vehicles and a speed of the vehicle may be the main cause of the past accident and thus history information may be updated based on the different past accident cause.

More specifically, based on whether a correspondence relationship between remaining causes, except for the erroneously estimated past accident cause, and the history information satisfies a preset criterion, a past accident cause may be determined. In this case, when a correspondence relationship between one past accident cause in the remaining past accident causes and the history information are compared with the preset criterion and then determined that the correspondence relationship does not satisfy the preset criterion, two past accident causes and the history information may be compared with the preset criterion to determine whether the correspondence relationship satisfies the preset criterion. For example, a correspondence relationship between environment information or road state information, except for driving information of the vehicle determined as an erroneously estimated past accident cause, and the history information may be compared to determine whether the correspondence relationship satisfies 70%. Alternatively, a correspondence relationship between a combination of environment information and road state information and history information may be compared to determine whether the correspondence relationship satisfies 70%.

In some implementations, the road state information and the environment information may be constantly monitored by other vehicles driving in a corresponding section and updated. Specifically, when a past accident occurred due to a pothole, the presence of the pothole may be constantly monitored by other vehicles driving in the corresponding section. When the pothole disappears, the history information may be updated in consideration of the disappearance of the pothole.

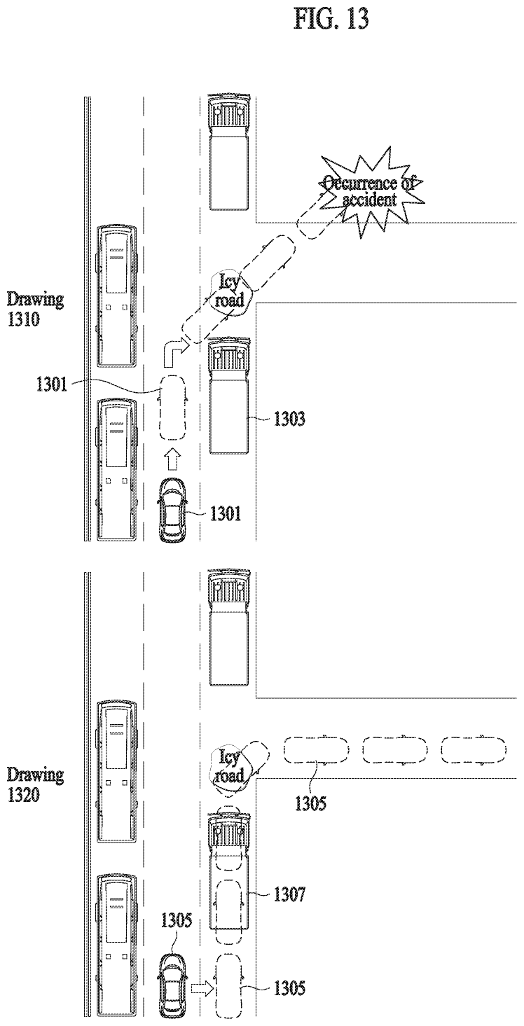

FIG. 13 is a diagram illustrating an example of avoidance driving according to an embodiment.

A drawing 1310 illustrates a case in which an accident occurred in a corresponding section in the past. In this case, when a vehicle 1301 overtook a truck 1303 to make a right turn to go to a destination, the accident occurred due to slipping of the vehicle 1310 on an icy road present in a region not sensible to the vehicle 1301. The vehicle 1301 may not be allowed to sense a region in front of the truck 1303 due to an arrangement relationship between the vehicle 1301 and the truck 1303. In this case, a past accident cause may correspond to environment information or road state information regarding an environment or road state of a region not sensible due to the arrangement relationship of the vehicles.

A drawing 1320 illustrates a case where occurrence of an accident is prevented in accordance with an alternative route and a defensive driving maneuver. A vehicle 1305 may drive along the same route of the vehicle 1301 which met with the accident in the past. When a correspondence relationship of driving information and sensing information of the vehicle 1305 to the past accident satisfies a preset criterion and thus an accident is predicted to occur, driving of the vehicle 1305 in accordance with a defensive driving maneuver or alternative route may be determined. In this case, a virtual collision route for the vehicle 1305 may be a route to make a right turn after overtaking a truck 1307. In order to avoid the predicted accident, the vehicle 1305 may drive in accordance with a defensive driving maneuver or alternative route. Specifically, the vehicle 1305 may perform the defensive driving maneuver of decelerating and moving behind the truck 1307 so that the vehicle 1305 drives following the truck 1307. In addition, since the presence of an icy road is predicted based on information on a front region sensed by the truck 1307, the vehicle 1305 may perform a defensive driving maneuver of making a right turn while driving slowly. Accordingly, the vehicle 1305 may be able to make a right turn safely without any accident. Here, the vehicle 1305 may prevent any accident by driving in accordance with the defensive driving maneuver, which is driving slowly, and an alternative route, which requires a lane change.

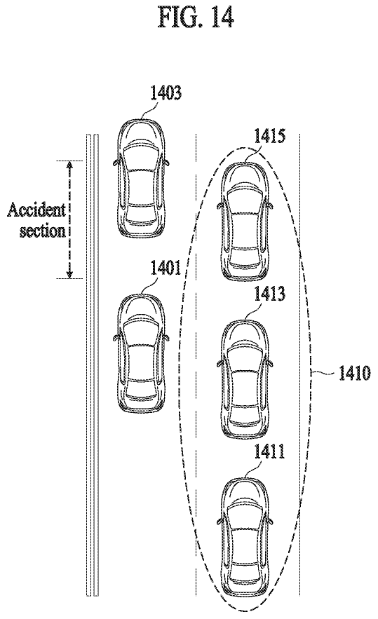

FIG. 14 is a view illustrating how to control an arrangement relationship between vehicles according to an embodiment.

When driving in an accident section in which an accident occurred in the past, a vehicle 1401 may be able to avoid an accident by driving in accordance with a combination of defensive driving maneuvers or alternative routes. In this case, an accident occurrence probability corresponding to each combination of defensive driving maneuvers or alternative routes may be determined. When the accident occurrence probability does not satisfy a predetermined criterion, a server may control driving a vehicle 1403 adjacent to the vehicle 1401 and platooning vehicles 1411, 1413, and 1415. For example, a control command may be transmitted through V2X communication so that the vehicle 1403 may accelerate. In another example, a control command may be transmitted through V2X communication so that the speed, spacing, or location relationship of the platooning vehicles 1411, 1413, and 1415 performing vehicle platooning 1410 may change. When a arrangement relationship between the vehicles 1403, 1411, 1413, and 1415 is changed by a control command, a defensive driving maneuver or alternative route of the vehicle 1401 may be reset. When the vehicle 1401 drives in accordance with the reset defensive driving maneuver or alternative route, safe driving of the vehicle 1401 may be ensured.

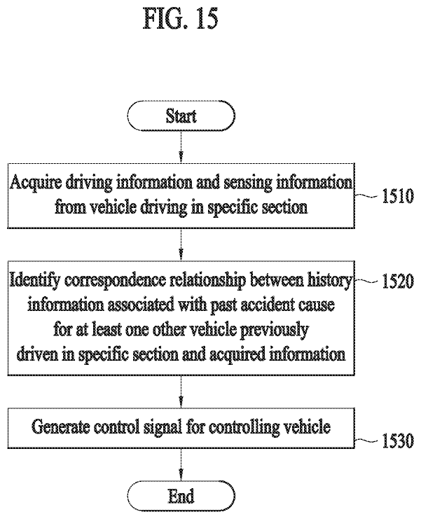

FIG. 15 is a flowchart of a method for controlling a vehicle according to an embodiment.

In operation 1510, driving information and sensing information may be acquired from a vehicle driving in a specific section.

In operation 1520, a correspondence relationship between a past accident cause for at least one other vehicle having driven in the specific section and relevant history information may be identified. Here, the history information may be learned based on the past accident cause for the past accident that occurred in the corresponding section. Here, the past accident cause may correspond to a cause related to the occurrence of the past accident.

A virtual collision route may be identified based on the acquired information and the history information. Specifically, the virtual collision route may be determined by a combination of the history information and the past accident cause. For example, when the past accident occurred due to road state information and arrangement information of vehicles, a virtual collision route in which an accident is predicted to occur when the vehicle drives along the virtual collision route may be determined based on comparison between information acquired from a vehicle currently driving and history information (the road state information and the arrangement information of the vehicles). More specifically, when a correspondence relationship between the information acquired from the vehicle currently driving and the history information (the road state information and the information on the arrangement of the vehicles) is equal to or greater than a predetermined criterion, at least one virtual collision route may be generated based on a combination of the road state information and the arrangement information of the vehicles. For example, when the vehicle currently driving continues to drive in the current driving lane, an accident with an adjacent vehicle driving in an adjacent lane may be predicted due to a pothole formed in a road, and a route of this case may be set as a virtual collision route.

A server may determine a defensive driving maneuver or alternative route to avoid the accident predicted to occur in the virtual collision route, and a control signal may be generated and transmitted to the vehicle so that the vehicle may drive in accordance with the defensive driving maneuver or alternative route. The control signal may include control information for controlling the vehicle to drive in accordance with the defensive driving maneuver or alternative route to avoid the accident predicted to occur in the virtual collision route.

In this case, the control information associated with the defensive driving maneuver or alternative route may be determined in consideration of information on a visible region and information on a non-visible region. The information on the visible region may be determined in consideration of driving information and sensing information acquired from the vehicle. The information on the non-visible region may be determined in consideration of driving information and sensing information acquired from an adjacent vehicle driving in an adjacent lane. The information on the non-visible region may be information on a region not sensible to the vehicle. A correspondence relationship of acquired information and history information to a past accident cause may be identified. Whether another subsequent vehicle driving along the virtual collision route meets with an accident may be monitored. If the subsequent vehicle driving along the virtual collision route does not meet with an accident, the past accident cause may have been erroneously estimated. Accordingly, history information may be updated based on a different past accident cause other than the erroneously estimated past accident cause.

The past accident cause may include at least one of the following: arrangement information of vehicles associated with the past accident, road state information of a section associated with the past accident, environment information associated with the past accident, and driving information of a vehicle associated with the past accident.

In operation 1530, a control signal for controlling the vehicle may be generated. When a correspondence relationship between acquired information and a past accident caused associated with the past accident satisfies a predetermined criterion, a virtual collision route for the vehicle may be identified. The vehicle may drive in accordance with a defensive driving maneuver or alternative route to avoid an accident predicted to occur in the virtual collision route. Here, the virtual collision route may be determined by a combination of at least one past accident cause of which a correspondence relationship to the acquired information is equal to or greater than the predetermined criterion. For example, when road state information or environment information has a correspondence relationship equal to or greater than 70% with respect to the acquired information, a virtual collision route may be determined by any one or a combination of the road sate information and the environment. When an accident is predicted to occur due to a pothole in a current driving lane, a virtual collision route may be determined based on road state information. In this case, the virtual collision route may be determined in consideration of not just driving information and sensing information acquired from the vehicle, but also driving information and sensing information acquired from another vehicle.

In this case, when at least one control signal is generated, an accident occurrence probability corresponding to each of the at least one control signal may be determined. The accident occurrence probability may include a probability of an accident predicted to occur when the vehicle is controlled in accordance with a corresponding control signal.

When the accident occurrence probability satisfies a predetermined criterion, the vehicle may be controlled in accordance with the corresponding control signal. If there is a plurality of predicted accident probabilities satisfying the predetermined criterion, the vehicle may be controlled in accordance with a control signal corresponding to a minimum accident occurrence probability. For example, optimal avoidance driving may be determined by comparing an accident occurrence probability P1 resulting from a defensive driving maneuver 1, an accident occurrence probability P2 resulting from a defensive driving maneuver 2, an accident occurrence probability P3 resulting from an alternative route 1, an accident occurrence probability P4 resulting from an alternative route 2, an accident occurrence probability P5 resulting from the defensive driving maneuver 1 and the alternative route 1, an accident occurrence probability P6 resulting from the defensive driving maneuver 1 and the alternative route 2, an accident occurrence probability P7 resulting from the defensive driving maneuver 2 and the alternative route 1, and an accident occurrence probability P8 resulting from the defensive driving maneuver 2 and the alternative route 2.

When the accident occurrence probability does not satisfy the predetermined criterion, driving of the at least one other vehicle driving in the corresponding section may be controlled and a control signal may be re-determined in consideration of a changed situation. For example, speed and spacing for adjacent vehicles driving in an adjacent lane or platooning vehicles may be controlled, and a virtual collision route may be reset in consideration of a changed situation. A control signal may be re-determined in response to the resetting of the virtual collision route, and the vehicle may be controlled in accordance with the re-determined control signal.

In some implementations, an accident frequently occurring on roads may be recognized in advance and thus prevented. In addition, a potential cause of the accident may be recognized in advance and thus an accident preventing operation corresponding to the cause may be performed.

According to embodiments of the present disclosure, there are one or more effects as below.

According to example embodiments, it is possible to prevent an accident as a vehicle drives in a specific section in accordance with a defensive driving maneuver or alternative route to prevent an accident that is predicted to occur according to history information based on a past accident.

According to example embodiments, it is possible to more accurately predict an accident and to improve driving stability of the vehicle through a defensive driving maneuver or alternative route since information sensed not just from a vehicle but also from another vehicle is used.

According to example embodiments, it is possible to ensure driving stability of the vehicle by controlling driving of another vehicle when an accident occurrence probability does not satisfy a predetermined criterion.

However, the effects of the present disclosure are not restricted to the one set forth herein. The above and other effects of the present disclosure will become more apparent to one of daily skill in the art to which the inventive concept pertains by referencing the claims.

Although various embodiments of the present disclosure have been described using specific terms, the specification and drawings are to be regarded in an illustrative rather than a restrictive sense in order to help understand the present invention. It is obvious to those skilled in the art that various modifications and changes can be made thereto without departing from the broader spirit and scope of the invention.

What is claimed is:

1. A method for controlling a vehicle in a computing device, the method comprising:
acquiring driving information and sensing information from the vehicle driving in a specific section;
identifying a correspondence relationship between history information associated with a past accident cause for at least one other vehicle having driven in the specific section and the acquired information; and
generating a control signal for controlling the vehicle based on the identified correspondence relationship.

2. The method of claim 1, wherein the past accident cause comprises at least one of the following: arrangement information of vehicles associated with a past accident, road state information of the specific section associated with the past accident, environment information associated with the past accident, and driving information of the at least one other vehicle associated with the past accident.

3. The method of claim 2, wherein:
the identifying of the correspondence relationship comprises identifying a virtual collision route for the vehicle based on the acquired information and the history information, and
the control signal comprises control information for controlling the vehicle to drive in accordance with a defensive driving maneuver or alternative route to avoid an accident predicted to occur in the virtual collision route.

4. The method of claim 3, wherein:
the control information associated with the defensive driving maneuver or alternative route is determined in consideration of information on a visible region and information on a non-visible region, and
the information on the visible region is determined in consideration of the driving information and the sensing information acquired from the vehicle, and the information on the non-visible region is determined in consideration of driving information and sensing information acquired from an adjacent vehicle driving in the specific section.

5. The method of claim 3, wherein the virtual collision route is a route in which an accident is predicted to occur when the vehicle drives along the route, and the virtual collision route is determined by a combination of information included in the past accident cause in consideration of the correspondence relationship of the acquired driving information and the acquired sensing information to the past accident cause.

6. The method of claim 3, further comprising, when at least one control signal is generated, determining a control signal in consideration of an accident occurrence probability corresponding to each of the at least one control signal,
wherein the accident predicted probability comprises a probability that an accident predicted to occur when the vehicle is controlled in accordance with the generated control signal.

7. The method of claim 6, further comprising, when the accident occurrence probability does not satisfy a predetermined criterion, controlling the at least one other vehicle driving in the specific section and re-determining the control signal in consideration of a changed situation.

8. A method for controlling a vehicle in a computing device, the method comprising:
acquiring driving information and sensing information from the vehicle in a specific section;
receiving a control signal generated based on a correspondence relationship between history information associated with a past accident cause for at least one other vehicle having driven in the specific section and the acquired information; and
driving in accordance with the control signal.

9. The method of claim 8, wherein:
the past accident cause comprises at least one of the following: arrangement information of vehicles associated with a past accident, road state information of the specific section associated with the past accident, environment information associated with the past accident, and driving information of the at least one other vehicle associated with the past accident, and
the control signal comprises control information for controlling the vehicle to drive in accordance with a defensive driving maneuver or alternative route to avoid an accident predicted to occur in a virtual collision route.

10. The method of claim 9, wherein:
the control information associated with the defensive driving maneuver or alternative route is determined in consideration of information on a visible region and information on a non-visible region, and
the information on the visible region is determined in consideration of the driving information and the sensing information acquired from the vehicle, and the information on the non-visible region may be determined in consideration of driving information and sensing information acquired from an adjacent vehicle driving in the specific section.

11. A server comprising:
a communicator configured to receive driving information and sensing information from a vehicle driving in a specific section; and
a processor configured to generate a control signal for controlling the vehicle based on a correspondence relationship between history information associated with a past accident cause for at least one other vehicle having driven in the specific section and the received information.

12. The server of claim 11, wherein the past accident cause comprises at least one of the following: arrangement information of vehicles associated with a past accident, road state information of the specific section associated with the past accident, environment information associated with the past accident, and driving information of the at least one other vehicle associated with the past accident.

13. The server of claim 12, wherein the processor is further configured to:
identify a virtual collision route for the vehicle based on the received information and the history information; and
generate a control signal including control information for controlling the vehicle to drive I accordance with a defensive driving maneuver or alternative route to avoid an accident predicted to occur in the virtual collision route.

14. The server of claim 13, wherein:
the control information associated with the defensive driving maneuver or alternative route is determined in consideration of information on a visible region and information on a non-visible region, and
the information on the visible region is determined in consideration of the driving information and the sensing information acquired from the vehicle, and the information on the non-visible region is determined in consideration of driving information and sensing information acquired from an adjacent vehicle driving in the specific section.

15. The server of claim 13, wherein the processor is further configured to determine the virtual collision route by a combination of information included in the past accident cause, the virtual collision route in which an accident is predicted to occur when the vehicle drives along the virtual collision route.

16. The server of claim 13, wherein:
when at least one control signal is generated, the processor is further configured to determine a control signal in consideration of an accident occurrence probability corresponding to each of the at least one control signal;
the accident occurrence probability comprises a probability of an accident predicted to occur when the vehicle is controlled in accordance with the generated control signal.

17. The server of claim 16, wherein, when the accident occurrence probability does not satisfy a predetermined criterion, the processor is further configured to control at least one other vehicle driving in the specific section and re-determine a control signal in consideration of a changed situation.
